(19) United States
(12) Patent Application Publication
(10) Pub. No.: US 2006/0262453 A1
(43) Pub. Date: Nov. 23, 2006

(54) Magnetic recording head and magnetic disk storage apparatus mounting the magnetic head

(75) Inventors: Masafumi Mochizuki, Tokyo (JP); Yasutaka Nishida, Tokyo (JP); Takehiko Hamaguchi, Kanagawa (JP); Kimitoshi Etoh, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Technologies Netherlands B.V., Amsterdam (NL)

(21) Appl. No.: 11/436,382

(22) Filed: May 17, 2006

(30) Foreign Application Priority Data
May 17, 2005 (JP) 2005-144514

(51) Int. Cl. G11B 5/127

(52) U.S. Cl. 360/125

(57) ABSTRACT

Embodiments of the invention provide a magnetic head which can suppress broadening of the magnetic field distribution in the track-width direction without reducing the magnetic field intensity. In one embodiment, a main pole is composed of a pole tip having a part providing a write-track width, and a yoke part recessed from the air bearing surface in the element-height direction, where the trailing side surface of the pole tip is made as an asymmetric structure with respect to the track center.

### CROSS-REFERENCES TO RELATED APPLICATIONS

This application claims priority from Japanese Patent Application No. JP2005-144514, filed May 17, 2005, the entire disclosure of which is incorporated herein by reference.

### BACKGROUND OF THE INVENTION

The present invention relates to a magnetic head for perpendicular recording and a magnetic disk storage which incorporates the same.

A magnetic recording system has a magnetic recording medium and a magnetic head, and data in the magnetic recording medium are read and written by the magnetic head. It is necessary to reduce the length of the recorded bit for improving the recording capacity per unit area of the magnetic recording medium. However, in current longitudinal recording systems, there is a problem that the recording density cannot be increased due to thermal fluctuation of magnetization of the medium when the recording bit length becomes smaller. One way to solve this problem is a perpendicular recording system in which magnetic signals are written in a direction perpendicular to the medium. There are two kinds of systems for perpendicular recording; one is a system which has a double-layer perpendicular medium with a soft under layer as a recording medium, and another is a system using a single layer perpendicular medium which does not have an under layer. In the case when a double-layer perpendicular medium is used for the recording medium, larger write-field intensity can be applied by writing using a single-pole-type writer which provides a main pole and an auxiliary pole.

FIG. 17 shows a relationship between a magnetic head 14 for perpendicular recording and a magnetic disk 11, and a schematic drawing of perpendicular recording. A magnetic head of the prior art has a stacked structure of a lower shield 8, a read element 7, an upper shield 9, an auxiliary pole 3, a thin film coil 2, and a main pole 1, in order, from the side of the direction of head motion (leading side). A read head 24 consists of the lower shield 8, the read element 7, and the upper shield 9, and the write head (single-pole-type writer) consists of the auxiliary pole 3, the thin film coil 2, and the main pole 1. The main pole consists of a yoke part of main pole 1A which is connected to the auxiliary pole through a pillar 17 and a pole tip 1B which is exposed to the air bearing surface and provides the track-width. The magnetic field which comes out of the main pole 1 of the write head 25 forms a magnetic circuit which enters the auxiliary pole 3 through the magnetic recording layer 19 and the soft under layer 20 of the magnetic disk 11, resulting in a magnetization pattern being written in the magnetic recording layer 19. An intermediate layer may be formed between the magnetic recording layer 19 and the soft under layer 20. A giant magneto resistive element (GMR) and a tunneling magneto resistive element (TMR) are used for a read element of the read head 24. It is preferable that the shape of the air bearing surface of the main pole be a trapezoidal shape which has a smaller width on the leading side, considering the case where the head has a skew angle.

FIG. 18 is a plane schematic drawing illustrating a main pole 1 of a write head of the prior art as seen from the trailing direction. The pole tip 1B connected to the yoke part of main pole 1A has a symmetrical shape with respect to the track center.

Moreover, since the auxiliary pole and the thin film coil exist between the read element and the main pole in the head structure shown in FIG. 17, there is a disadvantage that the format efficiency is deteriorated because the distance between the write element and the read element becomes large. Therefore, a structure is going to be applied in which the auxiliary pole 3 is arranged at the trailing side of the main pole 1. According to this structure, it becomes possible to make the distance between the write element and the read element smaller.

Moreover, along with the intensity of the write head magnetic field, the magnetic field gradient of the head magnetic field profile which determines the transition of the recorded bit, that is, the magnetic field gradient in the profile of the head magnetic field along the direction of head motion, is also an important element to achieve a high recording density. In order to achieve a higher recording density in the future, the field gradient has to be increased further. There is a structure to improve the write field gradient in which a magnetic material is arranged at the trailing side of the main pole 1. Moreover, there is a structure in which it is also arranged at the track-width side. In this structure, there is a case where the auxiliary pole is arranged at the trailing side of the main pole to form a closed magnetic circuit.

A magnetic head is usually fabricated by laminating magnetic films, in order, on a substrate by using a sputtering technique and a plating technique. Therefore, a structure of the prior art is one where the face of the main pole on the leading side is parallel to the substrate and perpendicular to the head air bearing surface. See, e.g., JP-A No. 94997/2004.

### BRIEF SUMMARY OF THE INVENTION

The present invention relates to a perpendicular recording system using a perpendicular recording head which has a main pole and an auxiliary pole and a double-layer perpendicular recording medium which has a soft under layer. Even in a perpendicular recording, a magnetic film having a large coercivity has to be used for the recording layer to provide it with a high recording density. Therefore, increases in the write-field intensity applied to the recording layer and in the write field gradient on the trailing side are necessary to achieve it. Moreover, making the magnetic field distribution narrower in the track-width direction is also important. The magnetization width written in the recording medium has to be made smaller by controlling the magnetic field distribution in the track-width direction. Moreover attenuation and elimination of magnetization information written in the adjacent tracks must be avoided by making the magnetic field intensity applied to the track adjacent to a writing track smaller.

One technique to achieve an increase in the write-field intensity is to bring the soft under layer close to the write head. However, in order to improve the resistance to demagnetization caused by thermal fluctuations, a certain thickness of a recording layer is required. Moreover, there are factors which impede reducing the distance between the soft under layer and the head, such as the flatness of the surface of the recording layer, lubricant, and the existence of a protective film over the head. Another technique is one where the film thickness of the head main pole is increased. It is possible to increase the magnetic field intensity by increasing the film thickness of the head main pole and increasing the area of the air bearing surface of the main pole, even if the track-width is the same. However, in the case a head has a skew angle, a magnetic field which is applied to the adjacent tracks is increased with increasing the film thickness of the main pole.

In a magnetic disk system, a suspension arm to which is fixed a head slider is scanned from the inside to the outside of a recording medium to perform read/write. Therefore, as shown in FIG. 19(a), the head has different angles against the recording track according to the position of the recording medium. This is a skew angle φ. The write-field intensity of the double-layer perpendicular medium system is distributed corresponding to the area which faces the head main pole. As shown in FIG. 19(b), in the case when the film thickness t of the main pole is increased, the area which faces the air bearing surface of the main pole is brought closer to the adjacent tracks, resulting in a large magnetic field being applied to the adjacent tracks. As a result, attenuation and elimination of data occur in the adjacent tracks. In the prior art, there is a technique in which the shape of the air bearing surface of the main pole is made in a trapezoidal shape having a smaller width at the leading side as shown in FIG. 19(c), considering the case when the write head has a skew angle. In the case when the shape of the air bearing surface of the main pole is made in a trapezoidal shape, the magnetic field intensity also decreases due to the reduction in the area. JP-A No. 94997/2004 also discloses something similar.

Moreover, in the case when a magnetic material is placed on both the trailing side and the track-width side, it is possible to increase the magnetic field gradient on the trailing side and to suppress the distribution in the track-width direction. However, there is the disadvantage that the magnetic field intensity decreases.

As mentioned above, for making a higher recording density it is essential to reduce the write track-width in the medium and to apply a large magnetic field intensity without attenuation and elimination of the data occurring in the adjacent tracks. This is a problem which must be solved in order to achieve a much higher recording density in a magnetic disk system using a perpendicular recording.

It is a feature of the present invention to provide a magnetic head for perpendicular recording and a fabrication method thereof, in which a large magnetic field intensity is maintained, the track width can be made narrower, and a large magnetic field intensity can be generated without attenuating and eliminating the adjacent tracks' data. Specifically, it is a feature of the present invention to provide a magnetic disk system in which the magnetic head for perpendicular recording is mounted.

A magnetic head of the present invention has a main pole and an auxiliary pole, and the main pole has a pole tip providing the write track-width and a yoke part recessed from the pole tip in the element-height direction. The pole tip has a shape with left-right asymmetry with respect to the center line in a track-width direction as seen from the trailing direction. The shape of the air bearing surface of the pole tip is a trapezoidal shape. Concretely, the throat heights of the pole tip are different left to right in the track-width direction, or the flare angles of the squeeze points are different left to right in the track-width direction. Moreover, the pole tip may have the squeeze point only on one side in the track-width direction.

Furthermore, a magnetic head of the present invention is one which has a main pole having different areas of the left and right sides with respect to the center line in the track-width direction as seen in the pole top from the trailing direction.

In the case when a magnetic head of the present invention is used for a magnetic recording system in which the shape of the pole tip seen from the trailing direction has left-right asymmetry with respect to the center line in the track-width direction, it is preferable that the pole tip has a shape such that the throat height on the side where the main pole projects substantially from the track due to the skew angle is larger than the throat height on the other side; or that the pole tip has a shape such that the flare angle of the squeeze point on the side where the main pole projects substantially from the track due to the skew angle is smaller than the flare angle of the squeeze point of the other side; or that the pole tip has a squeeze point only on the side opposite of the side where the main pole projects substantially from the track due to the skew angle. Moreover, it is preferable that a side shield composed of a magnetic material is provided sandwiching a non-magnetic layer on the side where the main pole projects substantially from the track due to the skew angle, on both sides of the track-width direction of the main pole.

Moreover, in the case when it is a magnetic recording system of the type in which overwrite is performed on existing recorded data, it is preferable that the pole tip have a shape such that the throat height on the side where overwrite is performed on the existing recorded data is greater than the throat height of the other side; that the pole tip has a shape such that the flare angle of the squeeze point on the side where overwrite is performed on the existing recorded data is smaller than the flare angle of the squeeze point of the other side; or that the pole tip has a squeeze point only on the side opposite of the side where overwrite is performed on the existing recorded data. It is preferable that a side shield composed of a magnetic material be provided sandwiching a non-magnetic layer on the side, where overwrite is performed on the existing recorded data, on both sides of the track-width direction of the main pole.

When seen from the trailing direction of the present invention, in the case when a magnetic head having different areas in the left and right sides with respect to the center line in the track-width direction is used for a magnetic recording system, it is preferable that the pole tip has a shape such that the area on the side, where the main pole projects substantially from the track due to the skew angle, is greater than the area of the other side with respect to the center line in the track-width direction.

Moreover, in the case when it is a magnetic recording system of the type in which overwrite is performed on the existing recorded data, it is preferable that the pole tip has a shape such that the area on the side, where overwrite is performed on the existing recorded data, is smaller then the area of the other side.

According to the structure of the present invention, a high write-field intensity can be generated even if the width of the magnetic field distribution along the direction of head motion is small, and even if the head has a skew angle, attenuation and elimination of data do not occur in the adjacent tracks and the recording density can be increased. Herein, the air bearing surface means the surface opposite a medium of the magnetic film constituting the head except the protective film composed of a non-magnetic material such as carbon, etc.

According to the present invention, a write head and a magnetic disk system housing it can be provided, in which the broadening of the distribution of the magnetic field in the track-width direction can be suppressed without reducing the maximum write-field intensity, the magnetic field applied to the adjacent tracks can be reduced, and the distance between tracks can be made narrower.

### BRIEF DESCRIPTION OF THE DRAWINGS

FIG. 1 is a schematic drawing illustrating a magnetic recording system.

FIG. 2A is a plane schematic drawing illustrating an example of a main pole part of a magnetic head of the present invention as seen from the trailing direction.

FIG. 2B is a perspective view drawing illustrating an example of a pole tip 1B of a magnetic head of the present invention.

FIG. 3 is a cross-sectional schematic drawing at the track center illustrating an example of a magnetic head of the present invention.

FIG. 4 is a figure showing a comparison of the write-field distributions in the track-width direction between a magnetic head of the present invention and a magnetic head of the prior art.

FIG. 5 is a figure showing the track-width dependence of the magnetic field intensity of a magnetic head.

FIG. 6 is a figure showing the throat height dependence of the magnetic field intensity of a magnetic head.

FIG. 7 is a plane schematic drawing illustrating another example of a main pole part of a magnetic head of the present invention as seen from the trailing direction.

FIG. 8 is a plane schematic drawing illustrating another example of a main pole part of a magnetic head of the present invention as seen from the trailing direction.

FIG. 9 is a plane schematic drawing illustrating another example of a main pole part of a magnetic head of the present invention as seen from the trailing direction.

FIG. 10 is a figure showing a comparison of the write-field distributions in the track-width direction between a magnetic head of the present invention and a magnetic head of prior art.

FIG. 11 is a plane schematic drawing illustrating another example of a magnetic head of the present invention as seen from the air bearing surface.

FIG. 12 is a plane schematic drawing illustrating another example of a main pole part of a magnetic head of the present invention as seen from the trailing direction.

FIG. 13 is a figure showing a comparison of the write-field distributions in the track-width direction between a magnetic head of the present invention and a magnetic head of the prior art.

FIG. 14A is a drawing showing a side where the magnetic field gradient of the present invention is improved.

FIG. 14B is a drawing showing a side where the magnetic field gradient of the present invention is improved.

FIG. 15 is a drawing illustrating a method for fabricating a magnetic head of the present invention.

FIG. 16 is a drawing illustrating another method for fabricating a magnetic head of the present invention.

FIG. 17 is a schematic explanatory drawing illustrating a perpendicular recording using a magnetic head of the prior art.

FIG. 18 is a plane schematic drawing illustrating a main pole of a magnetic head of the prior art as seen from the trailing direction.

FIG. 19 is a schematic drawing illustrating a skew angle and the area which faces the air bearing surface of the main pole.

### DETAILED DESCRIPTION OF THE INVENTION

Hereinafter, specific embodiments of the present invention will be described with reference to the accompanying drawings as follows. In each of the following drawings, the same functional part will be shown using the same code.

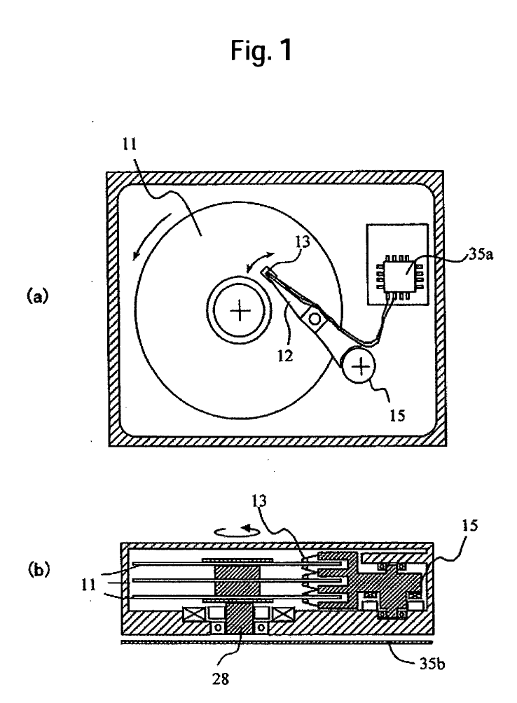

FIG. 1 is a conceptual illustration showing an example of a magnetic recording system of the present invention. The magnetic recording system reads/writes the magnetization signals by the magnetic head mounted on the slider 13 fixed at the tip of the suspension arm 12 at a predetermined position on the magnetic disk (magnetic recording medium) 11 being rotated by the motor 28. The position (track) can be selected in the magnetic disk radial direction of the magnetic head by driving the rotary actuator 15. The signals recorded to the magnetic head and the signals read from the magnetic head are processed in the signal processing circuits 35a and 35b.

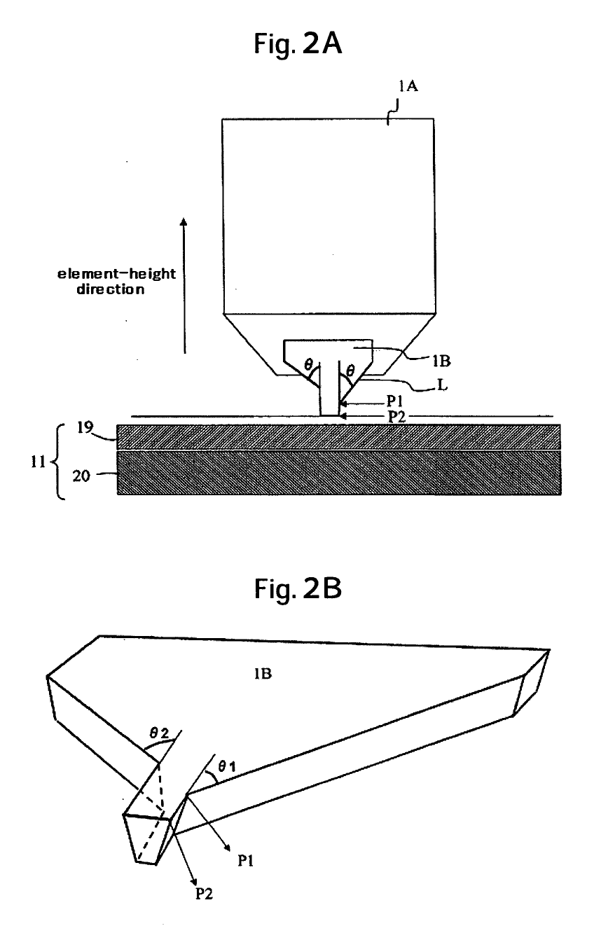

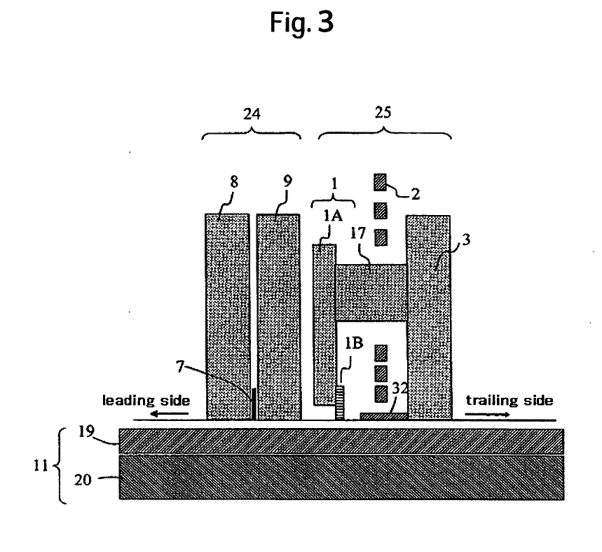

FIG. 2A is a drawing illustrating an example of a main pole which is mounted in a magnetic head of the present invention, and is a plane schematic drawing of the main pole as seen from the trailing direction. FIG. 3 is a cross-sectional schematic drawing at the track center illustrating an example of a magnetic head of the present invention. A cross-sectional schematic drawing of a magnetic recording medium 11 is also shown in the figure. Moreover, FIG. 2B is a perspective view drawing of the pole tip 1B of the main pole shown in FIG. 2A.

This magnetic head is a read/write merged head having a write head 25 providing the main pole 1 and the auxiliary pole 3, and a read head 24 providing the read element 7. The main pole 1 is magnetically connected to the auxiliary pole 3 by the pillar 17 at the position separated from the air bearing surface, and the thin film coil 2 is interlinked to the magnetic circuit consisting of the main pole 1, the auxiliary pole 3, and the pillar 17. The main pole 1 is placed on the leading side of the auxiliary pole 3. The main pole 1 consists of the yoke part of main pole 1A connected to the auxiliary pole 3 by the pillar 17, and the pole tip 1B which is exposed to the air bearing surface and provides the track-width. In order to concentrate the magnetic flux to the tip part providing the track-width which faces the medium, the pole tip 1B has a shape in which the so-called throat height has different shapes in the left and right sides with respect to the track center. Herein, the throat height means the length of pole tip from the air bearing surface to the position (squeeze point) where the ratio of change of the magnetic pole width in the track-width direction changes from the air bearing surface along the element-height direction. The read element 7 consisting of a giant magneto resistive element (GMR) and a tunneling magneto resistive element (TMR), etc. is placed between a pair of magnetic shields (reading shields) constituting the lower shield 8 on the leading side and the upper shield 9 on the trailing side.

The magnetic material 32 arranged at the trailing side of the main pole 1 is one for increasing the magnetic field gradient of the perpendicular component profile of the head field along the direction of head motion. In the structure shown in FIG. 3, the auxiliary pole 3 is arranged at the trailing side of the main pole 1, but the auxiliary pole 3 may be arranged at the leading side of the main pole 1.

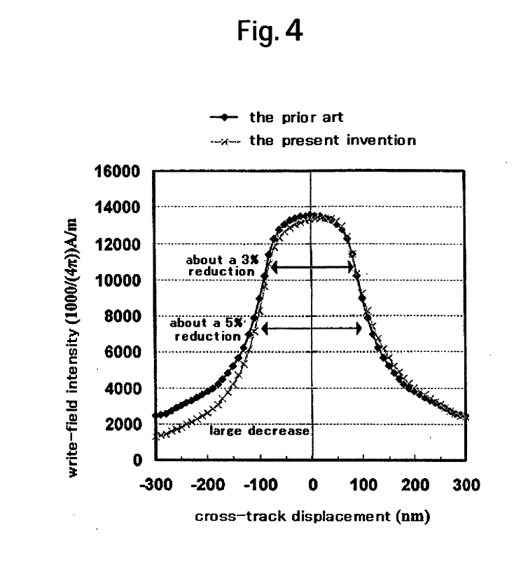

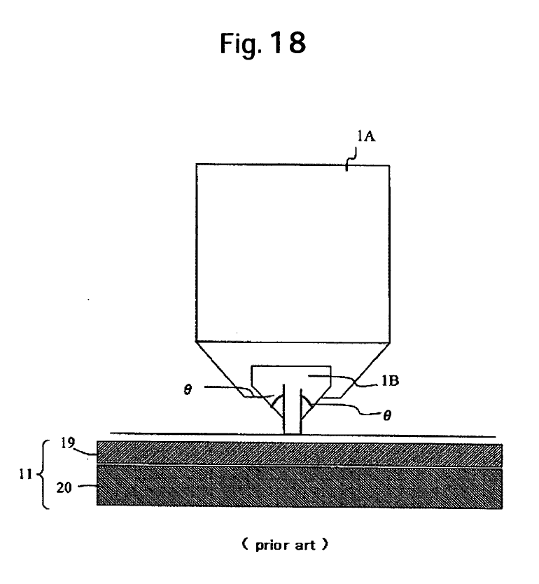

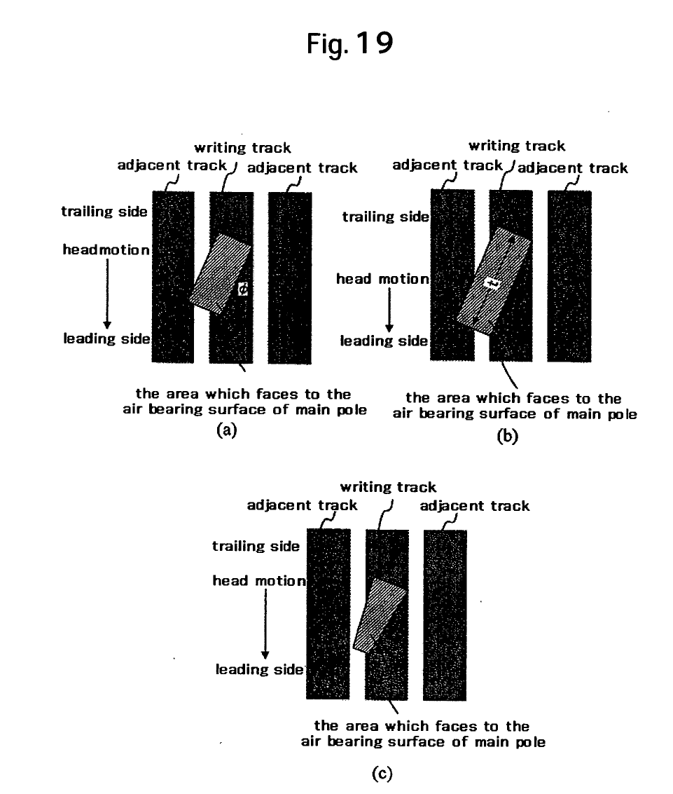

The write field intensity generated by the main poles was calculated by a three-dimensional magnetic field calculation for a magnetic head of the present invention which has a main pole having an asymmetric structure with respect to the track center as shown in FIG. 2A and for a magnetic head of the prior art which has a main pole having a symmetric structure with respect to the track center as shown in FIG. 18. The results are shown in FIG. 4.

The assumptions for the calculations are as follows. The dimensions of the pole tip 1B providing the track-width of the main pole of the magnetic head of the present invention shown in FIGS. 2A and 2B were assumed to be 90 nm in width and 200 nm in thickness. The shape of the air bearing surface was assumed to be a trapezoid in which the width at the leading side was smaller. The larger throat height was 2 μm and the smaller throat height was 100 nm. Herein, the throat height is a part which has the function to concentrate the magnetic flux by changing the rate of change in width along the track-width direction in the pole tip 1B. In FIG. 2A, the intersection P1 of the vicinity L of the pole tip 1B and the perpendicular extended in the element-height direction from the edge of the air bearing surface of the pole tip 1B is called the squeeze point, and the distance from the squeeze point P1 to the edge of the air bearing surface P2 of the pole tip 1B is the throat height. Moreover, in the schematic structural drawing shown in FIG. 2A illustrating the main pole as seen from the trailing side, the flare angle θ of the width of the pole tip 1B was assumed to be 45° both left and right of the squeeze point P1 at the boundary of the pole tip 1B.

Assuming CoNiFe to be the material for the pole tip 1B, the saturation magnetic flux density and the relative permeability were assumed to be 2.4 T and 500, respectively. 80at%Ni-20at%Fe with a saturation magnetic flux density of 1.0 T was assumed for the yoke part of the main pole 1A. A material with a saturation magnetic flux density of 1.0 T was assumed for the auxiliary pole 3, and the dimensions were 30 μm wide in the track-width direction, 16 μm long in the element-height direction, and a film thickness of 2 μm. 80at%Ni-20at%Fe with a saturation magnetic flux density of 1.0 T was assumed for the upper shield 9 and the lower shield 8, and the dimensions were 32 μm wide in the track-width direction, 16 μm long in the element-height direction, and a film thickness of 1.5 μm. The magnetic material 32 was omitted in order to simplify the calculation.

CoTaZr was assumed for the material for the soft under layer 20 of the magnetic recording medium; the distance from the head air bearing surface to the surface of the soft under layer 20 was 40 nm and the thickness of the soft under layer was 150 nm. The write-field intensity was calculated at a position assuming that the center position of the magnetic recording layer was a distance of 25 nm from the head air bearing surface. Only a film thickness of 20 nm for the medium recording layer 19 was considered.

The calculation was carried out for a magnetic head of the prior art, which has a main pole having a symmetric structure with respect to the track center shown in FIG. 18, using the same conditions of the shape and the material as the magnetic head described in the aforementioned embodiment except for the shape of the pole tip 1B of the main pole. The dimensions of the pole tip 1B were assumed to be 100 nm in width and 200 nm in thickness. The shape of the air bearing surface were a trapezoidal shape in which the width at the leading side is smaller. Both throat heights were assumed to be 100 nm.

FIG. 4 shows a comparison of the write-field distribution in the track-width direction of magnetic heads of the present invention and of the prior art. The horizontal axis of FIG. 4 is a distance in the head-width direction, and the vertical axis is the write-field intensity. In the case of the aforementioned conditions, according to the magnetic head of the present invention, broadening of the magnetic field in the track-width direction can be made smaller without deteriorating the write field intensity, resulting in a high recording density being achieved. Compared with a magnetic head of the prior art, a magnetic head of the present invention could achieve a 3% of reduction in the magnetic field width at around a magnetic field intensity as high as 11000× (1000/4π) A/m and about a 5% reduction in the magnetic field width at around a magnetic field of 7000× (1000/4π) A/m. Moreover, broadening of the magnetic field distribution can be suppressed in the range of small magnetic field intensity. This is due to the magnetic field intensity being compensated at one throat height, and the magnetic field distribution being made steeper in another throat height. In the calculation, the width of the pole tip 1B of the present invention is made 10 nm smaller than the conventional structure. However, when the width of the pole tip 1B in the conventional structure is made 10 nm smaller, the magnetic field intensity is reduced by about 1000× (1000/4π) A/m, so that the effect of the present invention shown in FIG. 4 cannot be obtained.

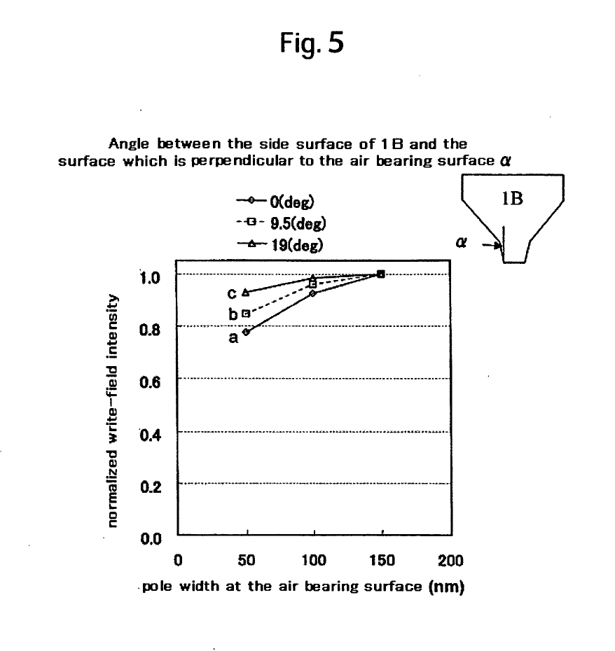

FIG. 5 illustrates the reason why such an effect is achieved by a main pole structure of the present invention. FIG. 5 shows the track-width dependence of the magnetic field intensity of the magnetic head, and the horizontal axis shows the pole width of the pole tip 1B at the air bearing surface and the vertical axis shows the normalized maximum magnetic field intensity. The normalized maximum magnetic field intensity means a value in which respective maximum magnetic field intensity is normalized by the maximum magnetic field intensity when the pole width of the pole tip 1B at the air bearing surface is 150 nm. The property “a” shown in the figure is one for the main pole where the throat height is perpendicular to the air bearing surface (α=0°). The property “b” is one for the main pole where the throat height tilts 9.5° against the air bearing surface (α=9.5°), and the property “c” is one for the head where the throat height tilts 19° against the air bearing surface (α=19°). According to the influence of the inclined surface, the head having α=19° can suppress the decrease in the maximum magnetic field intensity even if the pole width of the pole tip 1B at the air bearing surface is reduced. Therefore, as shown in FIG. 4, broadening of the distribution in the track-width direction can be suppressed even in the same maximum magnetic field intensity. Moreover, the head disclosed in JP-A No. 94997/2004 cannot bring about an effect like the present invention because only the air bearing surface has an asymmetric shape.

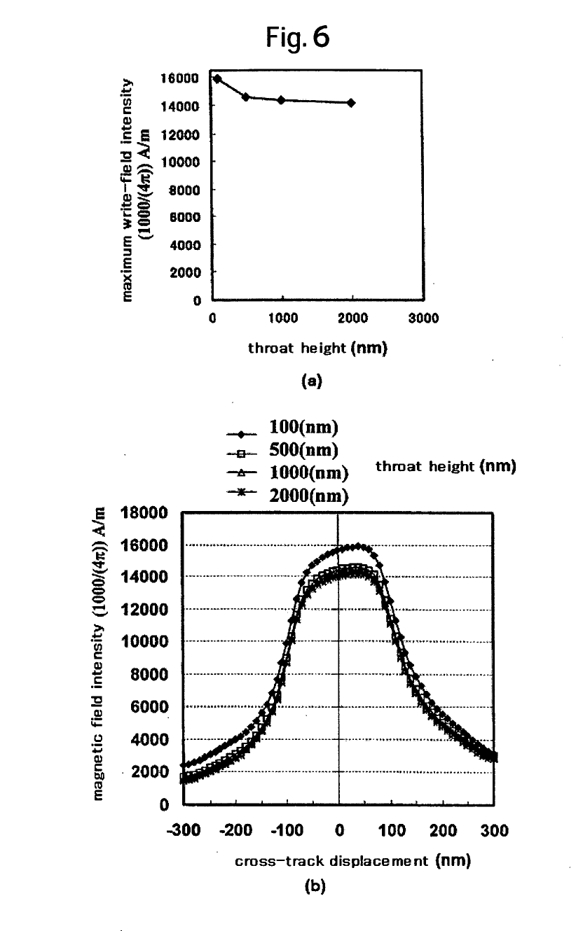

FIG. 6 shows the magnetic field intensity and magnetic field distribution when only one side of the throat height is changed. The horizontal axis of FIG. 6(a) shows the throat height, and the vertical axis shows the maximum intensity of the write-field. The horizontal axis of FIG. 6(b) shows the distance in the head-width direction, and the vertical axis shows the write-field intensity.

The dimensions of the pole tip 1B providing the track-width of the main pole of the magnetic head were assumed to be 100 nm in width and 200 nm in thickness. The shape of the air bearing surface was assumed to be a trapezoid in which the width at the leading side is smaller. One throat height (the smaller throat height) was fixed to be 100 nm, and the other throat height (the larger one) was allowed to change. Moreover, in the plane schematic drawing shown in FIG. 2A illustrating the main pole as seen from the trailing side, the flare angle θ of the width of the pole tip 1B from the squeeze point at the boundary of the pole tip 1B was assumed to be 45°. Assuming CoNiFe to be the material for the pole tip 1B, the saturation magnetic flux density and the relative permeability were assumed to be 2.4 T and 500, respectively. 80at%Ni-20at%Fe with a saturation magnetic flux density of 1.0 T was assumed for the yoke part of the main pole 1A.

A material with a saturation magnetic flux density of 1.0 T was assumed for the auxiliary pole 3, and the dimensions were 30 μm wide in the track-width direction, 16 μm long in the element-height direction, and a film thickness of 2 μm. 80at%Ni-20at%Fe with a saturation magnetic flux density of 1.0 T was assumed for the upper shield 9 and the lower shield 8, and the dimensions were 32 μm wide in the track-width direction, 16 μm long in the element-height direction, and a film thickness of 1.5 μm. CoTaZr was assumed for the material for the soft under layer 20 of the magnetic recording medium; the distance from the air bearing surface to the surface of the soft under layer 20 was 40 nm and the thickness of the soft under layer was 150 nm. The write-field intensity was calculated at a position assuming that the center position of the magnetic recording layer was at a distance of 25 nm from the air bearing surface. Only a film thickness of 20 nm for the medium recording layer was considered.

As seen in FIGS. 6(a) and 6(b), both the magnetic field distribution and the intensity stop changing when the larger throat height becomes about 500 nm or more. Therefore, it is preferable for a main pole of the present invention that the larger throat height be about 500 nm or more.

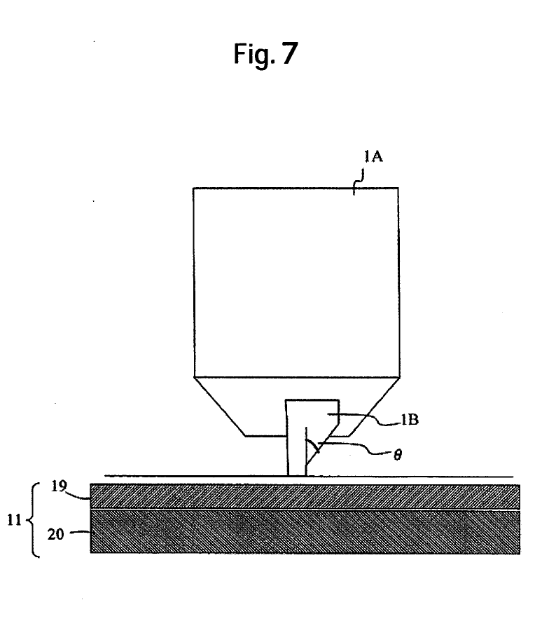

FIG. 7 is a plane schematic drawing illustrating another structural example of a main pole of a magnetic head of the present invention. This main pole of the magnetic head has a squeeze point only on one side, and the pole tip has a structure in which the shapes of the left side and the right side are different with respect to the track center. Such a structure of the main pole also brings about the effects described in FIG. 4.

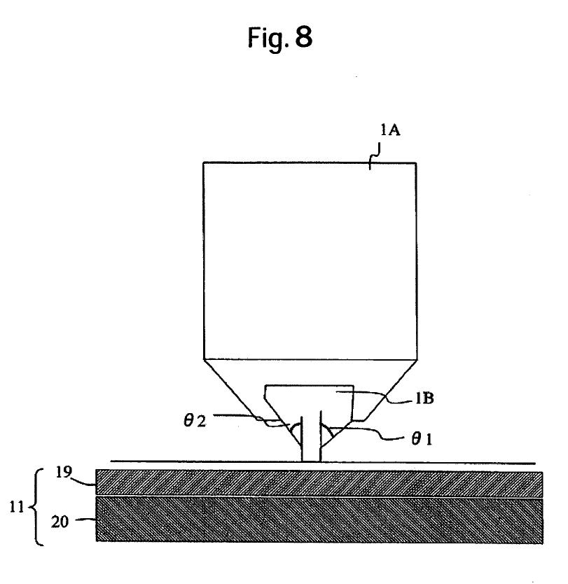

Moreover, FIG. 8 is a plane schematic drawing illustrating another structural example of a main pole of a magnetic head of the present invention. This magnetic head has a squeeze point in which the flare angles of the left and right sides, θl and θ2, are different and the pole tip has different structures on the left and right sides with respect to the track center. Such a structure of the main pole also brings about the effects described in FIG. 4.

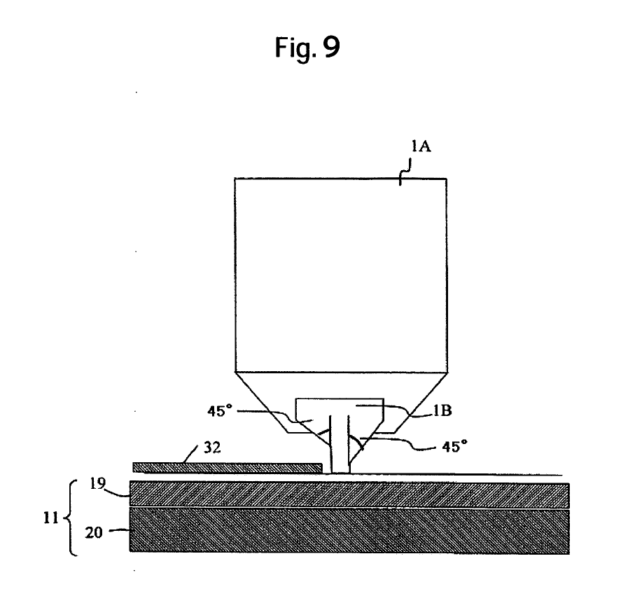

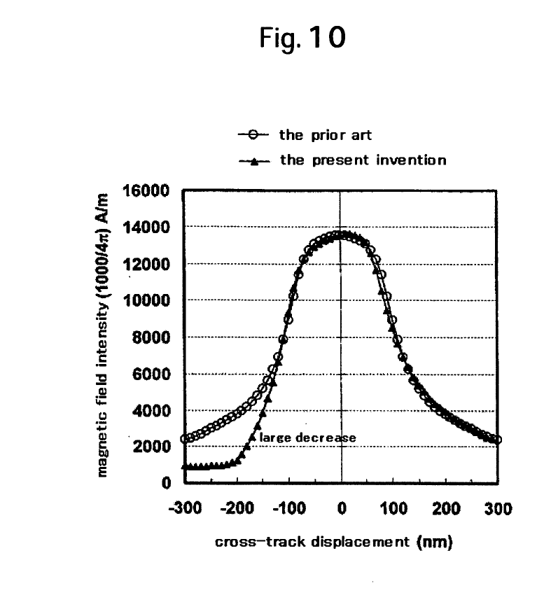

FIG. 9 is a drawing illustrating another embodiment of the present invention. In this embodiment, a shield 32 composed of a non-magnetic layer is arranged on one side of the main pole in the track width direction. In this embodiment, a shield 32 is arranged at the side of the larger throat height of the main pole. This shield 32 has the effect of suppressing the broadening of the magnetic field distribution. The write-field intensity generated by the main poles was calculated by a three-dimensional magnetic field calculation technique for a magnetic head of the present invention shown in FIG. 9 which has a main pole and a shield, and for a magnetic head of the prior art which has a main pole as shown in FIG. 18. The results are shown in FIG. 10.

The dimensions of the pole tip 1B shown in FIG. 9 providing the track-width of the main pole of the magnetic head were assumed to be 100 nm in width and 200 nm in thickness. The shape of the air bearing surface was assumed to be a trapezoid in which the width at the leading side was smaller. The larger throat height was 5 μm and the smaller throat height was 100 nm. Moreover, in the schematic structural drawing shown in FIG. 9 illustrating the main pole as seen from the trailing side, the flare angle of the width of the pole tip 1B from the squeeze point at the boundary of the pole tip 1B was assumed to be 45° from a line perpendicular to the air bearing surface. Assuming CoNiFe to be the material for the pole tip 1B, the saturation magnetic flux density and the relative permeability were assumed to be 2.4 T and 500, respectively. 80at%Ni-20at%Fe with a saturation magnetic flux density of 1.0 T was assumed for the yoke part of the main pole 1A.

A material with a saturation magnetic flux density of 1.0 T was assumed for the auxiliary pole 3, and the dimensions were 30 μm wide in the track-width direction, 16 μm long in the element-height direction, and a film thickness of 2 μm. 80at%Ni-20at%Fe with a saturation magnetic flux density of 1.0 T was assumed for the upper shield 9 and the lower shield 8, and the dimensions were 32 μm wide in the track-width direction, 16 μm long in the element-height direction, and a film thickness of 1.5 μm. The shield 32 was placed 100 nm away from the main pole in both the track-width direction and the trailing direction, and the film thickness in the element-height direction was assumed to be 50 nm. 80at%Ni-20at%Fe with a saturation magnetic flux density of 1.0 T was assumed for the material for the shield. CoTaZr was assumed for the material for the soft under layer 20 of the magnetic recording medium; the distance from the head air bearing surface to the surface of the soft under layer 20 was 40 nm and the thickness of the soft under layer 20 was 150 nm. The write-field intensity was calculated at a position assuming that the center position of the magnetic recording layer was at a distance of 25 nm from the head air bearing surface. Only a film thickness of 20 nm for the medium recording layer was considered.

The calculation was carried out for a magnetic head of the prior art, which has a main pole shown in FIG. 18, using the same conditions of the shape and the material as the magnetic head described in FIG. 9 except for the shape of the pole tip 1B of the main pole. The dimensions of the pole tip 1B were assumed to be 100 nm in width and 200 nm in thickness. The shape of the air bearing surface was assumed to be a trapezoid in which the width on the leading side is smaller. The throat heights were assumed to be 100 nm on both sides.

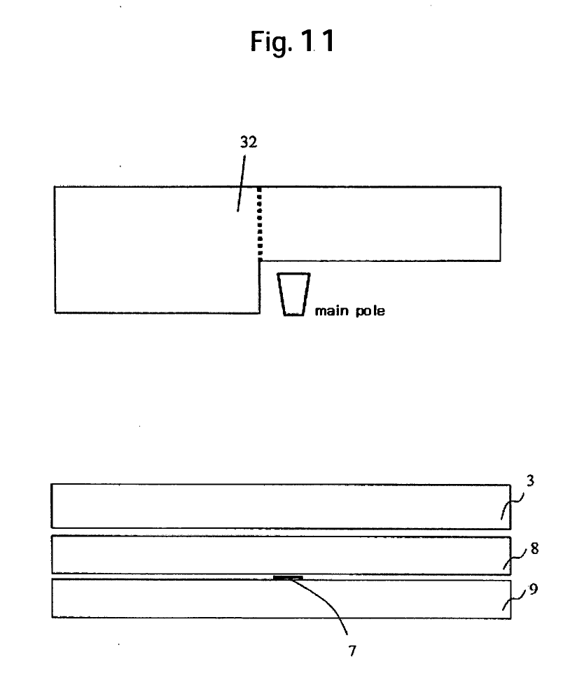

In FIG. 10, the horizontal axis shows the distance in the track-width direction and the vertical axis shows the write-field intensity. Comparing the head of this embodiment and that of the comparative example, it is understood that they have same maximum magnetic field intensity, but the magnetic field distribution on the left side shown in FIG. 10 can be made smaller in this embodiment. A larger magnetic field intensity can be obtained in the structure of this embodiment than a structure in which the side shields are arranged in the both sides. The side shield is provided on one side in this embodiment. However, as shown in FIG. 11, a shield composed of a magnetic material may be provided at the trailing side of the main pole. Moreover, it is not preferable that the edge part of the magnetic material of the shield be located in the vicinity of the main pole, and it is preferable that it be extended in the opposite track-width direction. The inventors discovered that, if the edge part of the magnetic material of the shield exists in the vicinity of the main pole, magnetic field leaks from the edge when an external magnetic field is applied to the hard disk drive. The inventors discovered that the influence can be avoided by extending it toward the opposite track-width direction.

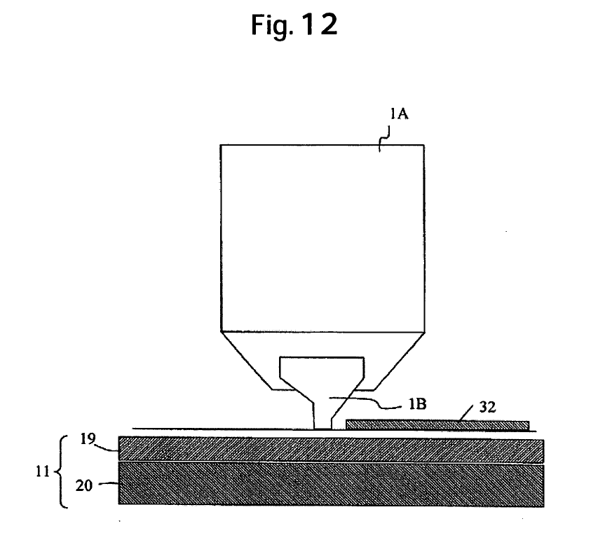

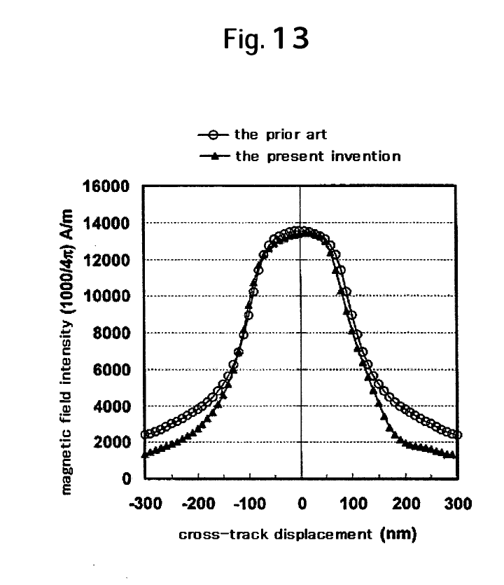

FIG. 12 is a drawing illustrating another embodiment of the present invention. In the embodiment, a shield 32 composed of a non-magnetic layer is arranged on one side of the main pole in the track width direction through a non-magnetic layer. In this embodiment, it was arranged at the side where the throat height of the main pole was smaller. The write-field intensity generated by the main poles was calculated by a three-dimensional magnetic field calculation for a magnetic head of the present invention shown in FIG. 12 which has a main pole and a shield, and for a magnetic head of the prior art which has a main pole as shown in FIG. 18. The results are shown in FIG. 13.

The dimensions of the pole tip 1B shown in FIG. 12 providing the track-width of the main pole were assumed to be 100 nm in width and 200 nm in thickness. The shape of the air bearing surface was assumed to be a trapezoid in which the width at the leading side was smaller. The larger throat height was 5 μm and the smaller throat height was 100 nm. Moreover, in the schematic structural drawing shown in FIG. 12 illustrating the main pole as seen from the trailing side, the flaring of the width from the squeeze point at the boundary of the pole tip 1B was assumed to be 45° on one side. Assuming CoNiFe to be the material for the pole tip 1B, the saturation magnetic flux density and the relative permeability were assumed to be 2.4 T and 500, respectively. 80at%Ni-20at%Fe with a saturation magnetic flux density of 1.0 T was assumed for the yoke part of main pole 1A.

A material with a saturation magnetic flux density of 1.0 T was assumed for the auxiliary pole 3, and the dimensions were 30 μm wide in the track-width direction, 16 μm long in the element-height direction, and a film thickness of 2 μm. 80at%Ni-20at%Fe with a saturation magnetic flux density of 1.0 T was assumed for the upper shield 9 and the lower shield 8, and the dimensions were 32 μm wide in the track-width direction, 16 μm long in the element-height direction, and a film thickness of 1.5 μm. The shield is placed 100 nm away from the main pole and the film thickness in the element-height direction was assumed to be 100 nm. 80at%Ni-20at%Fe with a saturation magnetic flux density of 1.0 T was assumed for a material for the shield. CoTaZr was assumed for the material for the soft under layer 20 of the magnetic recording medium; the distance from the head air bearing surface to the surface of the soft under layer 20 was 40 nm and the thickness of the soft under layer 20 was 150 nm. The write-field intensity was calculated at a position assuming that the center position of the magnetic recording layer was at a distance of 25 nm from the head air bearing surface. Only a film thickness of 20 nm for the medium recording layer was considered.

The calculation was carried out for a magnetic head, which has a main pole of the prior art shown in FIG. 18, using the same conditions of the shape and the material as the magnetic head described in FIG. 12 except for the shape of the pole tip 1B of the main pole. The dimensions of the pole tip 1B were assumed to be 100 nm in width and 200 nm in thickness. The shape of the air bearing surface was assumed to be a trapezoid in which the width on the leading side is smaller. The throat heights were assumed to be 100 nm on both sides.

In FIG. 13, the horizontal axis shows the distance in the track-width direction and the vertical axis shows the write-field intensity. Comparing the head of this embodiment with that of the comparative example, it is understood that they have same maximum magnetic field intensity, but the magnetic field distribution on both sides shown in FIG. 13 can be made smaller in this embodiment.

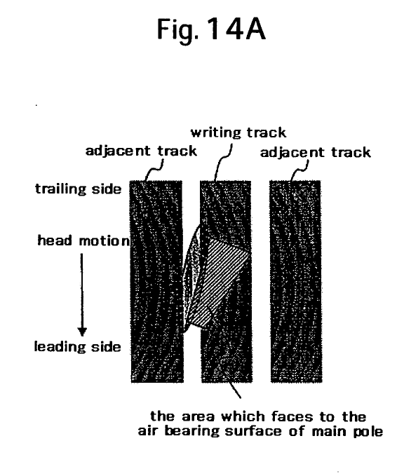

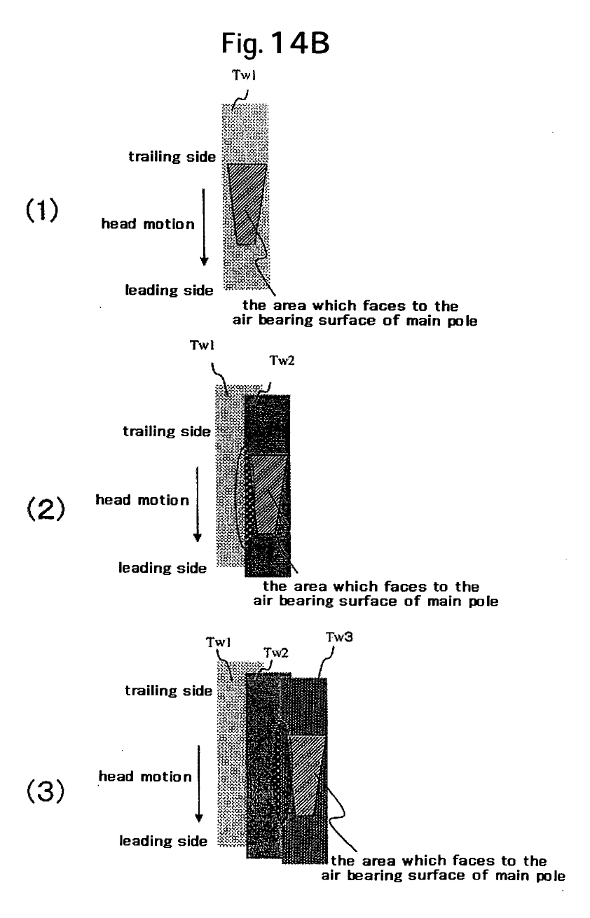

When a head having a structure of the present invention is used, a hard disk drive having a larger recording density can be achieved by arranging a head in which a structure making the magnetic field gradient steeper on the track side where a larger amount of pole tip 1B projects outward due to a skew angle as shown in FIG. 14A. In order to do this, one only has to arrange the head so that the side where the throat height of the pole tip of the main pole is larger, the side where the flare angle at the squeeze point is smaller, or the side where there is no squeeze point becomes on the side where the main pole projects substantially from the track. Alternatively, the side shield composed of a magnetic material may be arranged, with a non-magnetic layer between the side shield and the main pole where the main pole projects substantially from the track due to the skew angle. Moreover, it may be a system in which there is a skew angle and the head is arranged to make the side where the pole tip 1B projects outward from the track be either on the inner side or the outer side.

Moreover, as shown in FIG. 14B, the present invention may be applied to the case when the hard disk drive is so structured that the write tracks are layered. The track Tw1 is written according to FIG. 14B(1), and the track TW2 is written to overlap a part of track Tw1, as shown in FIG. 14B(2). Similarly, track Tw3 is written as shown in FIG. 14B(3). Such a recording technique is proposed in U.S. Pat. No. 6,185,063. At this time, a hard disk drive with higher density can be achieved by arranging a head of the present invention in a structure such that a steep magnetic field gradient is created at the track side where the write tracks are overlapped. For instance, in the case when writing is performed from the inner side to the outer side of the disk, the head is arranged so that a steep magnetic gradient is created at the outer side. Conversely, in the case when writing is performed from the outer side to the inner side of the disk, one only has to arrange the head so that a steep magnetic gradation is created at the inner side.

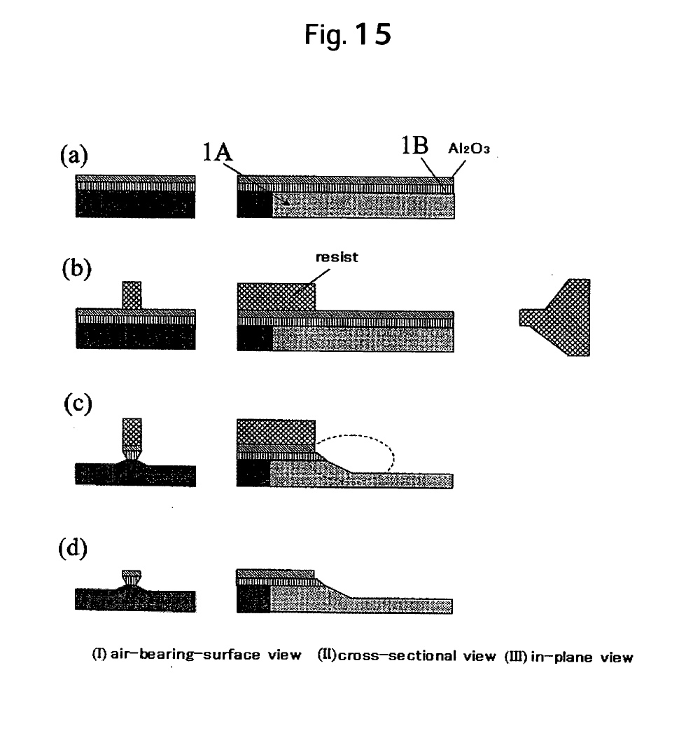

FIG. 15 shows a process for manufacturing a main pole having an asymmetric structure with respect to the track center by using ion milling. A magnetic film to be the pole tip 1B, for instance a 2.4 T CoNiFe or FeCo, is formed on the yoke part of main pole 1A by a sputtering technique or a plating technique. Next, Al₂O₃ is formed (FIG. 15(a)). Since Al₂O₃ has a selection rate against ion milling, it is effective in the case when a bevel angle is given to the main pole. The preferable film thickness of Al₂O₃ is about 100 nm or less. Next, a resist pattern of the present invention with an asymmetric shape is formed on the Al₂O₃ (FIG. 15(b)). It is better for patterning to use a stepper using a DUV (KrF and ArF) from the viewpoints of formation of a fine pattern and of overlapping precision of the sensor part in the element-height direction and the main pole flare part. After patterning, using the pattern as a mask, a pole tip of the main pole which has a bevel angle is formed using ion milling (FIG. 15(c)). During ion milling to form the main pole, since the part outside of the resist pattern is milled at the same time, a step circled by the broken line is created at the main pole and the yoke part of main pole. A desired shape of the main pole can be obtained by removing the resist by ashing or by using a remover (FIG. 15(d)) at the end.

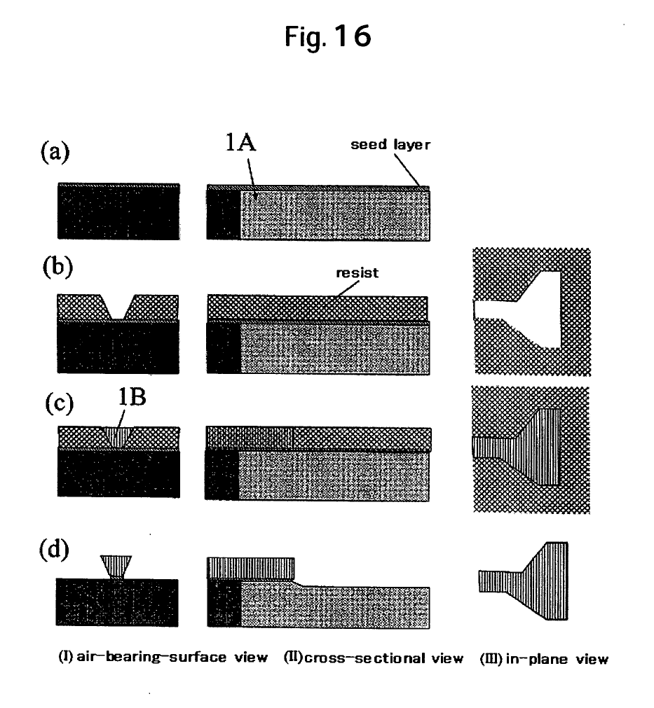

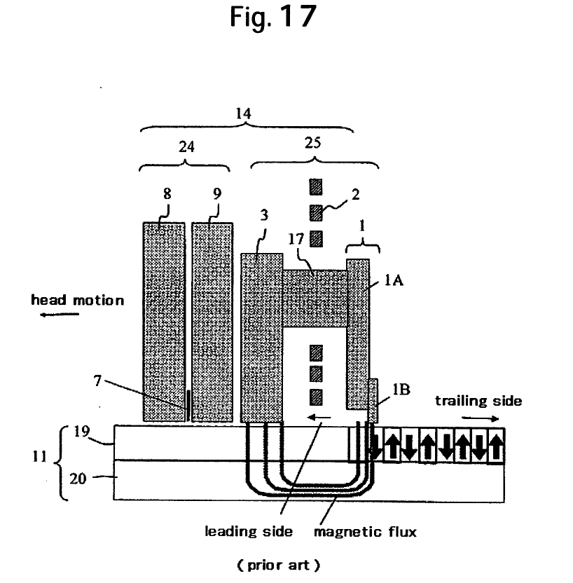

Aside from the aforementioned ion milling technique, a main pole which has an asymmetric structure with respect to the track center can be fabricated. FIG. 16 is a drawing illustrating a fabrication method using a frame plating technique. After forming a non-magnetic plating seed film (FIG. 16(a)) on the yoke part of main pole 1A, a resist having a bevel angle is formed (FIG. 16(b)). A resist to be a taper type is used for the resist to create a bevel angle. Plus focus (focus of 1.0 μm or more) may be used when a regular resist is exposed. It is better to employ a stepper using a DUV (KrF and ArF) from the viewpoints of formation of a fine pattern and of overlapping precision of the sensor part in the element-height direction and the main pole flare part. After forming the frame, a pole tip of the main pole is fabricated by a plating technique (FIG. 16(c)). After plating, removing the seed film and adjusting the size are carried out by an ion milling technique (FIG. 16(d)). In this case, since the time for ion milling becomes shortened, generation of a step between the main pole and the main pole yoke is small. Finally, the resist is removed to obtain a desired shape of the main pole.

It is to be understood that the above description is intended to be illustrative and not restrictive. Many embodiments will be apparent to those of skill in the art upon reviewing the above description. The scope of the invention should, therefore, be determined not with reference to the above description, but instead should be determined with reference to the appended claims along with their full scope of equivalents.

What is claimed is:

1. A magnetic head for a perpendicular recording comprising:
a main pole and an auxiliary pole,
wherein said main pole has a pole tip providing a write track-width and a yoke part recessed from said pole tip in an element-height direction, and
wherein said pole tip has a shape with left-right asymmetry with respect to a center line in a track-width direction as seen from a trailing direction.

2. A magnetic head according to claim 1, wherein
throat heights of said pole tip are different in the left and right sides in the track-width direction.

3. A magnetic head according to claim 1, wherein
flare angles of squeeze points at said pole tip are different in the left and right sides in the track-width direction.

4. A magnetic head according to claim 1, wherein
the shape of an air bearing surface of said pole tip is a trapezoid.

5. A magnetic head according to claim 1, wherein
said pole tip has a squeeze point only on one side of the track-width direction.

6. A magnetic head according to claim 1, wherein
a side shield composed of a magnetic material is provided on one side of the track-width direction of said main pole with a non-magnetic layer between said side shield and said main pole.

7. A magnetic head according to claim 6, wherein
a trailing shield composed of a magnetic material is provided, arranged on the trailing side said main pole with a non-magnetic layer between said side shield and said main pole, and said side shield is connected to said trailing side shield.

8. A magnetic head for a perpendicular recording comprising;
a main pole and an auxiliary pole,
wherein said main pole has a pole tip providing a write track-width and a yoke part recessed from said pole tip in an element-height direction, and
wherein said pole tip has a surface area which differs in the left and right sides with respect to a center line in a track-width direction as seen from a trailing direction.

9. A magnetic head according to claim 8, wherein
the shape of an air bearing surface of said pole tip is a trapezoid.

10. A magnetic head according to claim 8, wherein
said pole tip has a squeeze point only on one side of the track-width direction.

11. A magnetic head according to claim 8, wherein
a side shield composed of a magnetic material is provided on the one side in the track-width direction said main pole with a non-magnetic layer between said side shield and said main pole.

12. A magnetic head according to claim 11, wherein
a trailing shield composed of a magnetic material is provided, arranged on the trailing side said main pole with a non-magnetic layer between said side shield and said main pole, and said side shield is connected to said trailing side shield.

13. A magnetic recording system comprising;
a magnetic recording medium;
a media driving part which drives said magnetic recording medium;
a write head and a read head provided in a magnetic head which performs read and write operations to said magnetic recording medium; and
a head driving part which fixes the position of said magnetic head against said magnetic recording medium;
wherein said magnetic recording medium is a perpendicular recording medium which has a soft underlayer and a magnetic recording layer,
wherein said write head has a main pole and an auxiliary pole,
wherein said main pole has a pole tip providing a write track-width and a yoke part recessed from said pole tip in an element-height direction, and
wherein said pole tip has a shape with left-right asymmetry in a center line in a track-width direction as seen from a trailing direction.

14. A magnetic recording system according to claim 13, wherein
said pole tip has a shape such that a throat height on a side where said main pole projects substantially from the track due to a skew angle is larger than a throat height on another side thereof.

15. A magnetic recording system according to claim 13, wherein
said pole tip has a shape such that a flare angle of a squeeze point on a side where said main pole projects substantially from the track due to a skew angle, is smaller than a flare angle of a squeeze point on another side thereof.

16. A magnetic recording system according to claim 13, wherein
said pole tip has a squeeze point only on a side opposite of the side where said main pole projects substantially from the track due to a skew angle.

17. A magnetic recording system according to claim 13, wherein a side shield composed of a magnetic material is provided on a side of said main pole with a non-magnetic layer between said side shield and said main pole where said main pole projects substantially from the track due to a skew angle, on both sides of the track-width direction of said main pole.

18. A magnetic recording system according to claim 13, wherein
said pole tip has a shape such that a throat height on a side where overwrite is performed on the existing recorded data is greater than a throat height of another side thereof.

19. A magnetic recording system according to claim 13, wherein
said pole tip has a shape such that a flare angle of a squeeze point on a side where overwrite is performed on the existing recorded data is smaller than a flare angle of a squeeze point of another side thereof.

20. A magnetic recording system according to claim 13, wherein
said pole tip has a squeeze point only on a side opposite of a side where overwrite is performed on the existing recorded data.

21. A magnetic recording system according to claim 13, wherein
a side shield composed of a magnetic material is provided on a side of said main pole with a non-magnetic layer between said side shield and said main pole, where overwrite is performed on the existing recorded data, on both sides of the track-width direction of said main pole.

22. A magnetic recording system comprising;
a magnetic recording medium;
a media driving part which drives said magnetic recording medium; and
a write head and a read head provided in a magnetic head which performs read and write operations to said magnetic recording medium;
wherein, said magnetic recording medium is a perpendicular recording medium which has a soft underlayer and a magnetic recording layer,
wherein said write head has a main pole and an auxiliary pole,
wherein said main pole has a pole tip providing a read track-width and a yoke part recessed from said pole tip in an element-height direction, and
wherein said pole tip has an area which differs in the left and right sides with respect to a center line in a track-width direction as seen from a trailing direction.

23. A magnetic recording system according to claim 22, wherein
said pole tip has a shape such that an area on a side where said main pole projects substantially from the track due to a skew angle is greater than an area of another side with respect to the center line in the track-width direction.

24. A magnetic recording system according to claim 22, wherein
said pole tip has a shape such that an area on a side where overwrite is performed on the existing recorded data is smaller than an area of another side thereof.

25. A magnetic recording system according to claim 22, wherein a side shield composed of a magnetic material is provided on a side of said main pole with a non-magnetic layer between said side shield and said main pole, where overwrite is performed on the existing recorded data, on both sides of the track-width direction of said main pole.

26. A fabrication process for a magnetic head for a perpendicular recording which comprises a main pole and an auxiliary pole, in which said main pole has a pole tip providing the write track-width and a yoke part recessed from said pole tip in an element-height direction, and said pole tip has a shape with left-right asymmetry with respect to a center line in a track-width direction as seen from the trailing direction, said fabrication process comprising:
fabricating a magnetic film over said yoke part to be said pole tip;
fabricating an Al₂O₃ film thereon;
fabricating a resist pattern which has an asymmetric shape with respect to a track center;
fabricating said pole tip by an ion milling technique using said resist pattern as a mask; and
removing a residual resist.

27. A fabrication process for a magnetic head for a perpendicular recording which comprises a main pole and an auxiliary pole, in which said main pole has a pole tip providing the write track-width and a yoke part recessed from said pole tip in an element-height direction, and said pole tip has a shape with left-right asymmetry with respect to a center line in a track-width direction as seen from the trailing direction, said fabrication process comprising:
fabricating a non-magnetic plating seed film over said yoke part;
fabricating a resist pattern which has an asymmetric shape with respect to a track center;
fabricating said pole tip by plating over said seed film;
removing said seed film by an ion milling technique; and
removing a residual resist.
